(19) United States
(12) Patent Application Publication
(10) Pub. No.: US 2025/0242944 A1
(43) Pub. Date: Jul. 31, 2025

(54) A GROUND SUPPORT EQUIPMENT

(71) Applicant: ILLINOIS TOOL WORKS INC., GLENVIEW, IL (US)

(72) Inventors: Bo Vork NIELSEN, Fåborg (DK); Søren Risgaard DAHL, Rudkøbing (DK)

(73) Assignee: ILLINOIS TOOL WORKS INC., GLENVIEW, IL (US)

(21) Appl. No.: 18/705,044

(22) PCT Filed: Oct. 26, 2022
(86) PCT No.: PCT/US2022/047794

§ 371 Date: Apr. 26, 2024

(30) Foreign Application Priority Data
Nov. 8, 2021 (GB) 2116027.0

(51) Int. Cl. B64F 1/36; B64F 1/305; B64F 1/35

(52) U.S. Cl. CPC B64F 1/362; B64F 1/305; B64F 1/35

(57) ABSTRACT

The present disclosure provides a ground support equipment for servicing an aircraft on the ground. The ground support equipment comprises a pre-conditioned air. PCA, unit configured to provide pre-conditioned air to an aircraft on the ground. The ground support equipment also comprises a ground power unit. GPU, configured to provide power to the aircraft on the ground. The ground support equipment also comprises an input stage connectable to a power source and configured to provide a DC voltage. The input stage is operatively connected to the PCA unit and the GPU, and the GPU comprises an inverter circuit for transforming the DC voltage to a pre-determined output AC voltage for powering the aircraft.

This invention relates to a ground support equipment. More specifically, although not exclusively, this invention relates to a ground support equipment for servicing an aircraft at a boarding gate.

### BACKGROUND

A preconditioned air (PCA) unit is used to provide preconditioned (i.e., heated or cooled) air to an aircraft parked on the ground. By connecting the aircraft to a PCA unit the aircraft does not have to operate its auxiliary power unit (APU) to generate cooled or heated air onboard the aircraft.

Typically, the PCA unit is mounted to a passenger bridge at a boarding gate and is connected to the aircraft via a hose. A PCA unit typically includes an air conditioning unit arranged to cool air, which is then conveyed into the aircraft via the hose. Often, the PCA unit also includes a heater unit that is operable to heat air that is conveyed to the aircraft via the hose. The air conditioning unit or heater are selectively operated depending on the ambient temperature, for example so that when ambient temperatures are high air conditioning unit is operated to provide cooled air to the aircraft, and when ambient temperatures are low the heater is operated to provide heated air to the aircraft.

An additional ground support equipment which is often required when an aircraft is on the ground is a ground power unit (GPU). The GPU is used to power the aircraft's electrical systems so the aircraft does not need to generate its power using its APU. As the same GPU will be used for a range of different aircraft, including wide body and narrow body aircraft, GPUs are often designed for a worst-case scenario where maximum power will be needed by a wide body aircraft. This has led to large GPUs which occupy significant space on the tarmac around the aircraft or when mounted under the passenger bridge.

### BRIEF SUMMARY OF THE DISCLOSURE

Viewed from a first aspect, the present invention provides a ground support equipment for servicing an aircraft on the ground, the ground support equipment comprising: a pre-conditioned air, PCA, unit configured to provide pre-conditioned air to an aircraft on the ground, a ground power unit, GPU, configured to provide power to the aircraft on the ground, and an input stage connectable to a power source configured to provide a DC voltage, wherein the input stage is operatively connected to the PCA unit and the GPU, and wherein the GPU comprises an inverter circuit for transforming the DC voltage to a pre-determined output AC voltage for powering the aircraft.

Thus, the present invention provides a ground support equipment which is optimised for providing electrical power and pre-conditioned air to an aircraft being serviced on the ground. The ground support equipment of the present application also requires considerably less space, is lighter, and is considerably cheaper to produce compared to existing ground support equipment.

In examples, the input stage is connectable to the power source via a single cable. This further simplifies the installation of the ground support equipment compared to existing ground support equipment where a separate cable would be connected from the terminal building for each piece of ground support equipment, for example a PCA unit and a separate GPU, which in turn would require separate power panels for each cable. This considerably simplifies the installation process and ground support equipment inventory across an airport where large numbers of PCAs and separate GPUs are currently used and powered by separate power panels at each boarding gate.

In examples, the power source is an AC or DC voltage power source. In some cases, the power source may be a mains power source providing an AC or DC voltage. In some cases, the power source may be an external battery providing a DC voltage. In some cases, the ground support equipment comprises a battery, for example a rechargeable battery, configured to provide the power source to the input stage. Where an external battery is used, this provides further flexibility when servicing an aircraft on the ground, as the ground support equipment can be used when the aircraft is parked away from a boarding gate, and thus also away from the power panels typically installed at the boarding gate. The external battery may be separate to the ground support equipment or integral with the ground support equipment. In examples, the input stage comprises a transformer configured to transform an AC voltage power source to a pre-determined voltage level, and a rectifier. In examples the rectifier is an uncontrolled magnetic coupled rectifier or a switched rectifier. In examples, the pre-determined input voltage is an AC voltage. In some cases, the AC voltage is 550 VAC. The 550 VAC input enables the rectifier to output 690 VDC which enables the compressors of the PCA unit to be run up to 75 Hz with a constant V/f ratio. This advantageously provides a high power factor AC/DC converter with low current distortion while ensuring the required DC link voltage.

In examples, the pre-determined output AC power of the GPU is less than 90 kW, for example at most 45 kW. In examples, the pre-determined output AC power of the GPU is less than 75 kW. In examples, the pre-determined output AC power of the GPU is less than 50 kW. By providing an output power which is rated for the aircraft demand, the present ground support equipment is optimised for different aircraft. In examples, the pre-determined output AC power of the GPU is rated 45 kW. This advantageously provides ground support equipment that is optimised for narrow body aircraft which rarely require more than 20-30 kW of power when at the gate, despite prior art GPUs typically having a power rating of 90 kW. As narrow body aircraft make up about ⅔ of the global passenger aircraft fleet, the optimised ground support equipment is therefore optimised for existing passenger aircraft fleet. A 45 kW power is exemplary, as the power can be based on known actual aircraft power consumption and will vary from this exemplary power output.

In examples, the ground support equipment comprises a controller configured to reduce the cooling capacity of the PCA unit when the power drawn by the GPU is above a pre-determined threshold. By reducing the cooling capacity of the PCA unit in this manner, this reduces the risk that the ground support equipment exceeds its maximum input current. A further advantage of reducing the cooling capacity of the PCA unit in this way is that the aircraft's power demands are prioritised over the cooling capacity provided by the PCA unit only for the time of increased power demand by the aircraft. Once the power demands of the aircraft reduce to below the pre-determined threshold, the cooling capacity of the PCA unit can revert to its normal levels and normal levels of cooling can be provided to the aircraft.

In examples, the GPU comprises a cable for connecting the GPU to the aircraft. In examples, the cable is detachable from the GPU. In examples, the cable is integrally connected to the GPU at one end.

In examples, the ground support equipment comprises a mounting mechanism for mounting the ground support equipment to a passenger boarding bridge. In examples, the mounting mechanism includes one or more clamps or brackets or attachment points for mounting the ground support equipment to the passenger boarding bridge. In examples, the one or more clamps or brackets or attachment points are distributed around a frame or housing of the ground support housing.

In examples, the ground support equipment comprises a housing, and the PCA unit and the GPU are arranged in the housing. The housing may be mountable to passenger boarding bridge, or it may be mountable on a vehicle or on the apron.

In examples, the PCA unit comprises an air duct for conveying air through the PCA unit. The air duct may have a first stage air duct. The air duct may have a narrowed section. The air duct may have a rectilinear cross-section. In some cases, the PCA unit includes only a single stage air duct. This advantageously provides a smaller ground support equipment. The air duct may have a second stage air duct that is joined to the first stage air duct at the narrowed section. For example, the narrowed section may be located approximately centrally between an inlet and an outlet of the PCA unit, and may be positioned approximately centrally within the housing of the ground support equipment. In examples, a blower fan is located at the narrowed section of the air duct and operable to drive air through the air duct.

In examples, at least some components of the GPU are housed between the narrowed section and the housing of the ground support equipment. That is, where the narrowed section provides additional space between the air duct and the housing, at least some GPU components can be accommodated. Specifically, the GPU may comprise one or more filters, for example an electromagnetic interference, EMI, filter, which can be accommodated within the housing at the narrowed section of the air duct. Similarly, the GPU may comprise one or more transformers and/or inverters, which can be accommodated within the housing at the narrowed section of the air duct.

In examples, the ground support equipment may comprise a PCA housing with the PCA unit arranged therein, and a GPU housing with at least a part of the GPU arranged therein, and wherein the GPU housing is separate to the PCA housing. In particular, an inverter of the GPU may be disposed in the GPU housing.

### BRIEF DESCRIPTION OF THE DRAWINGS

Aspects of the present ground support equipment are described hereinafter with reference to the accompanying drawings, in which:

FIG. 1 illustrates a perspective view of an aircraft parked on the ground, at a passenger bridge, with a ground support equipment having a preconditioned air, PCA, unit mounted to the passenger bridge;

FIG. 2A illustrates a frame and air duct of an alternative exemplary ground support equipment with the external panels omitted for clarity;

FIG. 2B illustrates an air conditioning module of the ground support equipment of FIG. 2A.

FIG. 3 illustrates a side view of the ground support equipment of FIG. 2A;

FIG. 4 illustrates a partial magnified view of a part of the ground support equipment shown in FIG. 3;

FIG. 5 illustrates an alternative side view of the ground support equipment of FIG. 2A;

FIG. 6 illustrates a partial magnified view of a part of the ground support equipment shown in FIG. 5;

FIG. 7 is a schematic representation of an exemplary power circuit of an exemplary ground support equipment.

### DETAILED DESCRIPTION

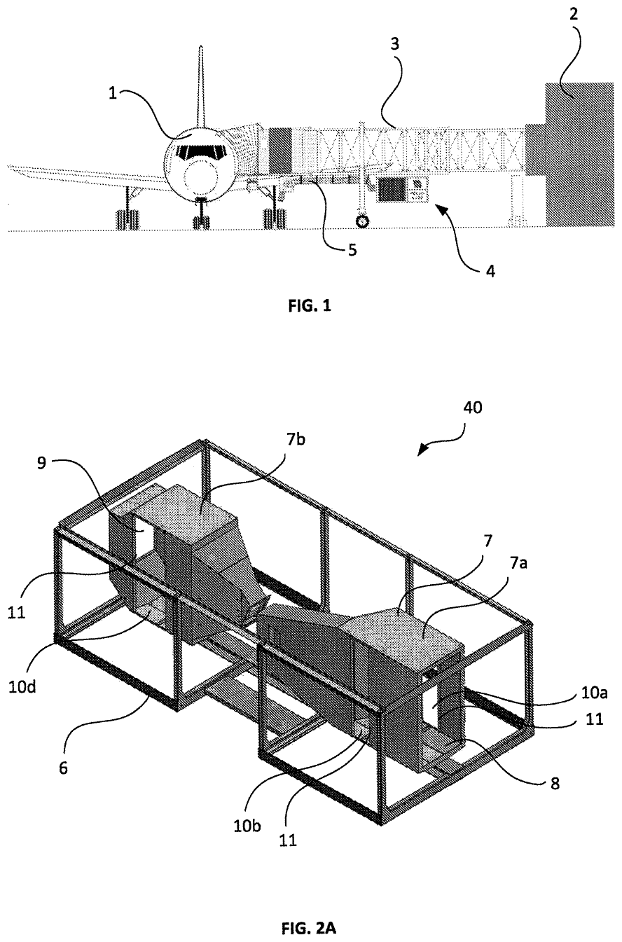

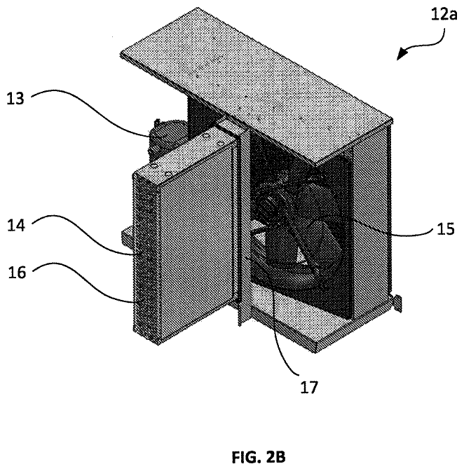

As shown in FIG. 1, when an aircraft 1 is parked on the ground, particularly at an airport boarding gate 2, a passenger bridge 3 may be positioned for boarding and disembarking the aircraft 1. A ground support equipment 4 may be mounted to the passenger bridge 3 for servicing the aircraft 1. In the illustrated example, the ground support equipment 4 includes a preconditioned air, PCA, unit (see also FIG. 2A) which can supply pre-conditioned air (i.e., heated or cooled air) to the aircraft 1. The ground support equipment 4 also includes a ground power unit, GPU, for providing power to the aircraft 1. This is in contrast to existing systems, where the PCA unit and the GPU would be separate pieces of equipment which have different input power ratings and would need separate power sources to operate. As will be explained below, the present ground support equipment 4 is able to combine the functionality of a PCA unit with that of a GPU in order to provide a unitary piece of ground support equipment 4 which is easier to install as a single power cable can be used to power the entire ground support equipment 4 (i.e. both the PCA unit and the GPU have the same power supply). In other examples, the ground support equipment 4 may be mounted under the passenger bridge 3, or the ground support equipment 4 may be located at the apron, in a hangar, or on a vehicle. The ground support equipment 4 includes a PCA unit having a single air duct. The single air duct may include a narrowed section around which other components can be arranged as explained below. However, it would be apparent that the ground support equipment may include multiple air ducts as required.

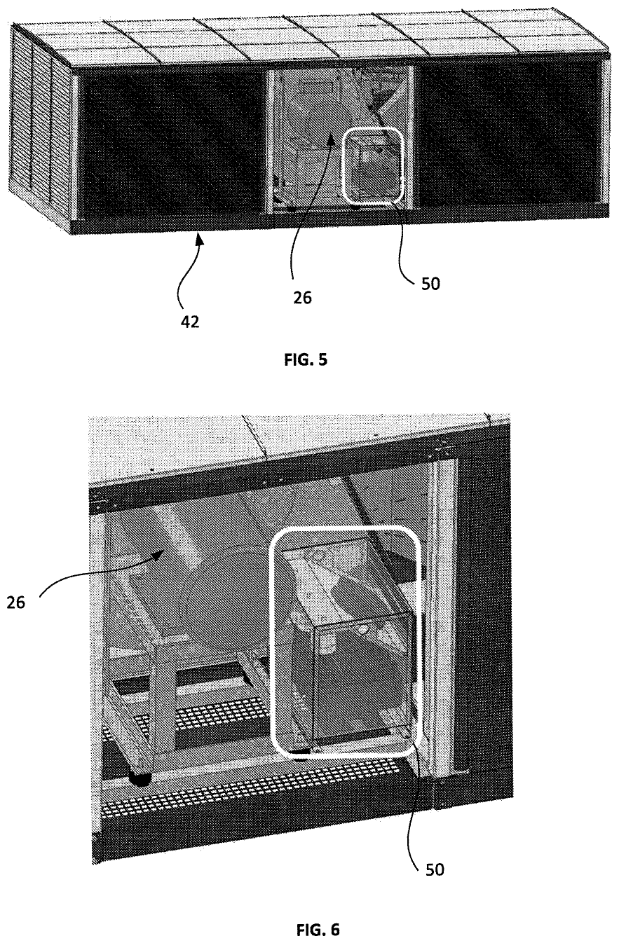

With reference to FIGS. 2A to 6, the ground support equipment 40 has a housing 41 containing a PCA unit 42 and a GPU 44. The GPU 44 is shown comprising three parts. Specifically, the GPU 44 includes an inverter 46, a transformer 50 and an output contactor 48. In some cases, the transformer 50 includes a filter, for example an electromagnetic interference, EMI, filter, for reducing noise and interference. As shown in FIG. 4, the inverter 46 and output contactor 48 is located on an electronics panel of the GPU 44. As shown in FIG. 6, the transformer 50 and/or filter is arranged in a narrowed section of the air duct 7 and adjacent the blower 26 which is also located in the narrowed section of the air duct 7. While FIGS. 4 and 6 show the transformer filter 50 arranged on the opposite side of the air duct 7 to the electronics panel containing the inverter 46 and output contactors 48, it would be apparent this was merely exemplary. In some cases, for example different arrangements of the air duct 7, the transformer filter 50 can be located on the same side of the air duct 7 as the electronics panel containing the inverter 46 and the output contactors 48. In other examples, at least a part of the GPU, for example the inventor 46, may be located outside of the housing 41, for example in a separate GPU housing (not illustrated). The separate GPU housing may be attached to the housing 41, or separate therefrom. The GPU housing may be mounted in a similar location to the housing 41, for example on an air bridge, on a vehicle, in a hangar, or on another apron structure. A frame 6 of the housing 41 of the ground support equipment 40 is shown, with the exterior panels removed. As shown, the ground support equipment 40, in particular the PCA unit 42, comprises an air duct 7. In the illustrated example the air duct 7 is formed of a first stage air duct 7a and a second stage air duct 7b. In use, ambient air is drawn into the first stage air duct 7a, passes through the first stage air duct 7a and into the second stage air duct 7b. Accordingly, the first stage air duct 7a comprises an air inlet 8, and the second stage air duct 7b comprises an air outlet 9. The PCA unit 42 draws ambient air from the environment, and heats or cools the air as it passes through the air duct 7. The PCA unit 42 comprises one or more air conditioning modules arranged to cool the air as it passes through the air duct 7, and/or one or more heaters arranged to heat the air as it passes through the air duct 7. FIG. 2B illustrates an example air conditioning module 12a that is mountable to one of the mounting points 10 in the air duct 7 shown in FIG. 2A. The air conditioning module 12a comprises a refrigerant system comprising a compressor 13, a condenser (not shown), an expansion valve (not shown), and an evaporator 14 connected in series in a refrigerant circuit. The refrigerant circuit contains a refrigerant. The refrigerant system operates in accordance with well-known refrigerator principles and detailed description is not included here.

A condenser fan 15 may be provided to generate an air flow over the condenser in order to increase heat dissipation on the external side of the PCA unit 42. The condenser fan 15 may be mounted in an aperture of the exterior panels of the PCA unit 42. One condenser fan 15 may be provided for each of a plurality of air conditioning modules 12a, or a single condenser fan 15 may operate to generate air flow over the condenser of more than one of the air conditioning modules 12a. The evaporator 14 has a large number of channels 16 for passage of the air flow in the air duct 7 providing a large surface area for heat exchange between the air flow and the refrigerant flowing inside the evaporator 14.

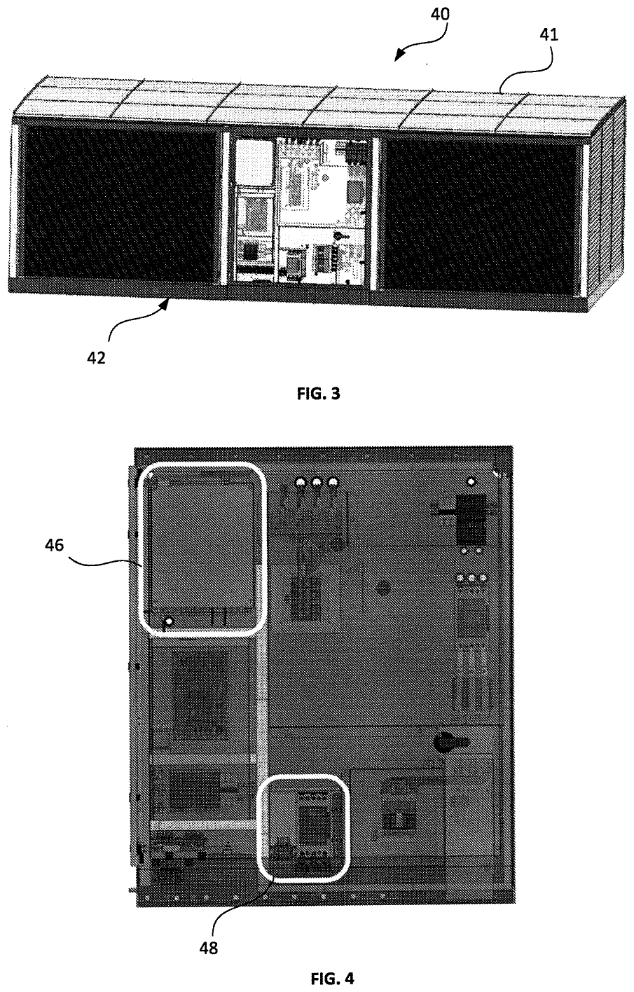

As illustrated in FIG. 2B, the air conditioning module 12a has a plate 17 arranged to close the slot 11 in the air duct 7 at the respective mounting point 10 shown in FIG. 2A. Accordingly, when the air conditioning module 12a is positioned within the PCA unit 4 the evaporator 14 extends into the air duct 7, and the compressor 13, condenser fan 15 and other components remain exterior of the air duct 7. Each condenser fan 15 is arranged with one side adjacent to the condenser and one side open to atmosphere through a respective opening in the housing of the PCA unit 4. The pre-conditioned (i.e., heated or cooled) air is conveyed to the aircraft 1 via a hose 5 connected to the air outlet 9. As explained below and illustrated in FIGS. 3 to 6, at least some of the components of the GPU 44 are distributed within the housing 41 around at least some of the components of the PCA unit 42.

A blower fan 26 may be provided at the air inlet 8, at the air outlet 9, at the junction of the first and second stage air ducts 7a, 7b, or at any other location along the air duct 7 to drive an air from the inlet 8 to the outlet 9 through the air duct 7. The air outlet 9 is connected to the hose 5 to convey the preconditioned air to the aircraft 1. The blower fan is preferably a highly efficient centrifugal fan. The blower fan is preferably mounted with vibration dampers and attached with flexible connections to the air duct 7 of the frame 6. The air duct 7 may be dimensioned for low air speed in order to prevent free moist carryover. The air duct 7 includes a narrowed section where the first and second stage air ducts 7a, 7b are joined.

The narrowed section may provide space in the middle of the frame 6 which can contain additional components for operating the ground support equipment 40. For example, components of the GPU may be located in this space, between the narrowed section of the air duct 7 and the housing 41. In particular, as described further below, the GPU 44 may include one or more filters (e.g., an EMI filter), transformers 50 and/or inverters 46, which are relatively large components and can be housed between the air duct 7 and the housing 41 in proximity to the narrowed section where the first and second stage air ducts 7a, 7b are joined. Additional components for the PCA unit 42 can also be located in this space, such as the blower 26 for driving air through the PCA unit 42. However, it would be apparent the blower 26 of the PCA unit 42 may be arranged differently within the housing 41, dependent on the specific design of the air duct 7 and surrounding frame 6.

The ground support equipment 40 illustrated in FIGS. 2A to 6 includes a GPU 44 and a PCA unit 42. It would be apparent this was merely exemplary and that other arrangements of the GPU components 46, 48, 50 and the PCA unit 42 are envisaged. The housing 41 of the ground support equipment 40 can include a mounting mechanism for mounting the ground support equipment 40 to the underside of a passenger bridge 3 shown in FIG. 1 or on a vehicle on the apron.

By housing the PCA unit 42 and GPU 44 in the single housing of the ground support equipment 40 the overall size of the ground support equipment 40 is reduced compared to a separate PCA unit and GPU, and so the ground support equipment 40 will occupy less space where it is located, for example under the passenger bridge 3.

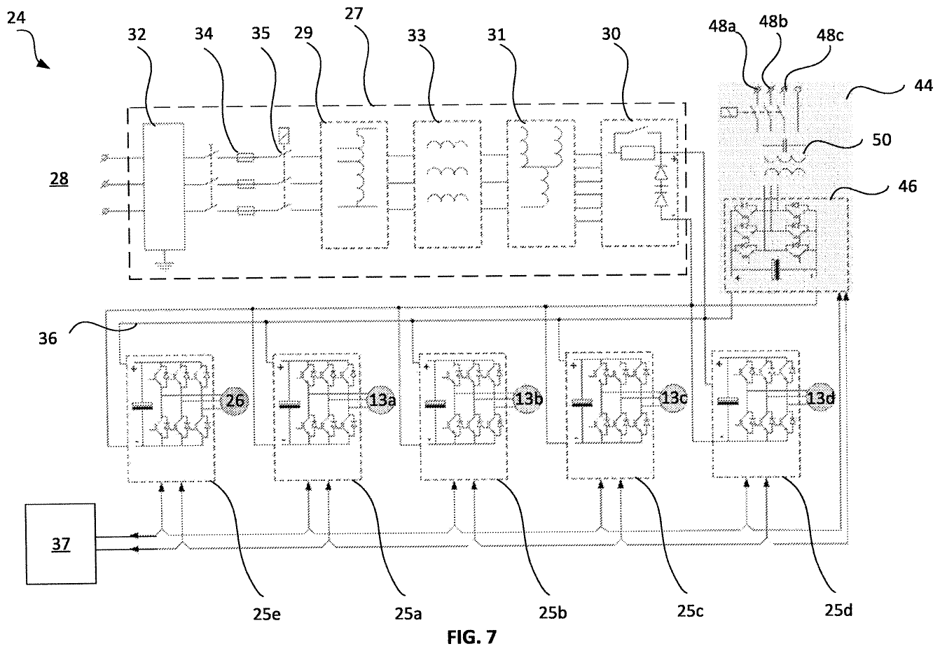

FIG. 7 is a schematic representation of an exemplary power circuit 24 of an exemplary ground support equipment 40. As explained above, the GPU 44 shares the same power source as PCA unit 42. This is possible as an input rectifier 30 is used to provide a DC bus voltage which both the GPU 44 and the PCA unit 42 can draw power from. In some cases, the rectifier 30 of the input stage 27 outputs 690V DC. Thus, only one power input is required for the ground support equipment 40 to provide the functionality of a GPU 44 and PCA unit 42. By connecting the PCA unit 42 and the GPU 44 to the same input stage 27, this further reduces the components required to provide cooling and power to the aircraft 1, resulting in a more compact ground support equipment.

The GPU 44 includes an inverter 46 to convert the voltage from the DC bus to a pre-determined AC voltage that is suitable for operating the particular aircraft 1 to be serviced, for example a three phase 400 Hz AC voltage. Preferably the GPU 44 has a maximum output power of less than 90 kW, for example less than 75 kW, for example 45 kW. By reducing the output power of the GPU 44 compared to existing GPUs which are typically rated at maximum 90 kW, the size of the ground support equipment 40 is reduced and the installation process on the passenger bridge 3 can be simplified. Preferably the GPU 44 has an output voltage of 3×200V/115V at 400 Hz.

Contactors 48 on the GPU 44 provide an output port to which the aircraft 1 can be connected, for example via a cable (not shown) mounted on the passenger bridge 3 or on the ground support equipment 40. In some cases, the output contactor 48 is situated next to the EMI filter 32.

In some examples, the input stage 27 can include a transformer 29 for transforming mains AC voltage which the input stage 27 is not rated for to a pre-determined input voltage. This advantageously allows the present ground support equipment 40 to be used in a greater variety of territories or operating conditions, particularly those which have a mains voltage different to the pre-determined input voltage. For example, the rectifier 31 may output 690 VDC.

The controller 37 is able to balance the power within the power circuit 24 to ensure the input current for the ground support equipment 40 does not exceed a pre-determined maximum input current. The controller 37 may reduce the cooling capacity of the PCA unit 42 if the input current exceeds a pre-determined threshold. Once the input current reduces to normal levels, i.e., falls below the pre-determined threshold, the controller 37 can restore the cooling capacity of the PCA unit 42. Temporarily adjusting the cooling capacity to ensure the power required by the aircraft is prioritised over the cooling of the aircraft is unlikely to have a detrimental effect when servicing the aircraft 1.

In the power circuit 24 illustrated in FIG. 7, the power circuit 24 comprises a variable frequency drive 25a-25d, VFD, for driving each air conditioning module of a respective PCA unit 42. First to fourth VFDs 25a-25d are arranged to provide power to a respective compressor 13a-13d of four air conditioning modules distributed within the housing 41, along the air duct 7, to provide the cooling capacity of the PCA unit 42 illustrated in FIG. 2A to 6. Where heating is desired, heating elements may be provided to heat the air within the PCA unit 42. A fifth VFD 25e is provided to power a blower fan 26 arranged to drive air through the air duct 7 as described above. In the illustrated example, the PCA unit 42 has four air conditioning modules (indicated by compressors 13a-13d and the VFD's 25a-25d), but in other examples the PCA unit 42 has at least one air conditioning module, for example one, two, three or four air conditioning modules, arranged to cool air as it passes through the PCA unit 42. Each air conditioning module has a compressor 13a-13d that is powered by a VFD 25a-25d. The compressor 13a-13d is connected to a refrigeration circuit that would be well known, typically having an expansion valve, a condenser, and an evaporator arranged within the air duct such that air flowing over the evaporator is cooled. In the present example, referring to FIG. 2A, two air conditioning modules are arranged in the first stage air duct 7a in positions 10a and 10b, and two air conditioning modules are arranged in the second stage air duct 7b in position 10d and another position on the opposite side not shown in FIG. 2.

The inverter 46 for the GPU 44 is shown as a sixth variable frequency drive, VFD which can be controlled to provide an AC output to the transformer 50 and the output contactors 48. While a VFD is one example of an inverter 46 suitable for providing the AC output for the aircraft 1, it would be apparent this was merely exemplary.

The power circuit 24 comprises an input stage 27 that typically receives AC input power from an external source 28, in particular the mains power available at the passenger bridge 3 or from a generator, as appropriate. In some cases, an external battery (not shown) or external DC power source may be used to power the ground support equipment 40. The external battery, when provided, can be integral to the ground support equipment, for example by being contained within the housing. Where the external battery is separate to the ground support equipment, for example to allow for different external rechargeable batteries to be used to power the ground support equipment, this may be provided as a system including the ground support equipment and at least one external battery. The input stage 27 converts the input voltage. For example, the input voltage may be 400 VAC. The input stage 27 may comprise a transformer 29 for altering the voltage, and/or a rectifier 30 for converting the AC input voltage to a DC voltage supply for the VFDs 25a-25e, 46.

In order to suppress distortion and pollution of the mains supply, the input stage 27 may comprise a 12-, 18- or 24-pulse transformer 31 upstream of the rectifier 30. The input stage 27 may additionally comprise an EMI filter 32, and/or a line inductor 33, and/or fuses 34 and/or contactors 35, as appropriate.

The input stage 27 outputs DC voltage to a DC bus 36. The DC bus 36 is connected to the VFDs 25a-25e, 46. Each VFD 25a-25e, 46 comprises an inverter stage having a plurality of switches, preferably IGBTs. Each VFD 25a-25e, 46 is operable to control the switches to generate three-phase AC power. The switches of each VFD 25a-25e, 46 can be controlled to vary the waveform of each phase of the three-phase AC power output. Also, the switches of each VFD 25a-25e, 46 can be controlled to vary the voltage, frequency and phase alignment of the three-phase AC power output.

As mentioned above, in this example the power circuit 24 comprises five VFDs 25a-25e for the PCA unit 42 and a further VFD 46 for driving the GPU 44. The first to fourth VFDs 25a-25d are each associated with an air conditioning module of the PCA unit 42, in particular a compressor 13a-13d of each air conditioning module. The fifth VFD 25e is provided to power an electric motor of the blower fan 26. The first to fourth VFDs 25a-25d are capable of being operated to vary the output frequency between 0 Hz to the maximum frequency of the compressor 13a-13d, for example between about 35 Hz and about 75 Hz. The fifth VFD 25e may be operable to vary the frequency between zero and about 55 Hz to vary the speed of the blower fan 26. The VFD 46 of the GPU 44 is operable to output a 400 Hz signal for providing power to the aircraft 1.

The ground support equipment 40 has a controller 37 that is configured for controlling the operation of the ground support equipment 40, including the power circuit 24. The controller 37 may be connected to a user interface for reception of user commands from a user and for outputting messages to the user. The ground support equipment 40 may comprise at least one of the following: a user interface panel with input keys and a display, a remote control, a computer interface, a network interface, a loudspeaker, etc. For example, one of the primary user entries may specify the type of aircraft to be serviced by the ground support equipment 40. This information may be entered using entry keys of the user panel, or, using a remote control from the passenger boarding bridge, or, may be transmitted from the building management system of the airport 2, etc. A control line is provided between the controller and each of the VFDs 25a-25e, 46. The control line may operate on 24 VDC. The control line may consist of an auxiliary power supply and a control signal connection, for example a CAN bus connection.

As illustrated, the VFDs 25a-25d are operable to provide a variable frequency power to the compressors 13a-13d of the respective air conditioning modules. The output voltage and frequency supplied by each VFD 25a-25d is controlled by the controller 37 in a way known in the art of variable frequency drivers. Each VFD 25a-25d is independently controllable, so the operation of each compressor 13a-13d (and air conditioning module) can be independently controlled by the controller 37. The controller 37 may control operation of the compressors 13a-13d based on, for example, the temperature and/or flow rate of the air flow in the flow duct. In particular, the controller 37 may output an individual temperature setting to each of the first to fourth VFDs 25a-25d and, in response to the individual temperature setting, each of the first to fourth VFDs 25a-25d may control the respective compressor 13a-13d and/or heater unit to adjust the temperature of the air flow as required.

The controller 37 is configured to operate the PCA unit 42 in a cooling mode, to cool air as it passes through the PCA unit 42. This can be achieved by the controller 37 controlling the first to fourth VFDs 25a-25d to operate the compressors 13a-13d and the fifth VFD 25e to operate the blower fan 26 such that air being driven through the PCA unit by the blower fan 26 is cooled as required. In some examples the PCA unit 42 may additionally comprise a heater and the PCA unit 42 may be operated in a heating mode to power the heater and the fifth VFD 25e of the blower fan 26 so as to heat air as it passes through the PCA unit 42. The control of VFD 25a-25d are independent of the control of the GPU inverter 46, so the operation of the GPU 44 and PCA unit 42 can be independently controlled by the controller 37.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A ground support equipment for servicing an aircraft on the ground, the ground support equipment comprising:
a pre-conditioned air, PCA, unit configured to provide pre-conditioned air to an aircraft on the ground,
a ground power unit, GPU, configured to provide power to the aircraft on the ground, and
an input stage connectable to a power source and configured to provide a DC voltage,
wherein the input stage is operatively connected to the PCA unit and the GPU, and
wherein the GPU comprises an inverter circuit for transforming the DC voltage to a pre-determined output AC voltage for powering the aircraft.

2. The ground support equipment according to claim 1, wherein the input stage is connectable to the power source via a single cable.

3. The ground support equipment according to claim 1, wherein the power source is an AC or DC voltage power source.

4. The ground support equipment according to claim 3, wherein the power source is an AC voltage power source and the input stage comprises a transformer configured to transform the AC voltage to a pre-determined voltage level, and a rectifier.

5. The ground support equipment according to claim 4, wherein the rectifier is an uncontrolled magnetic coupled rectifier or a switched rectifier.

6. The ground support equipment according to claim 1, wherein the pre-determined output AC power of the GPU is less than 90 kW, for example at most 45 kW.

7. The ground support equipment according to claim 1 comprising a controller configured to reduce the cooling capacity of the PCA unit when the power drawn by the GPU is above a pre-determined threshold.

8. The ground support equipment according to claim 1, wherein the GPU comprises a cable for connecting the GPU to the aircraft.

9. The ground support equipment according to claim 1, comprising a mounting mechanism for mounting the ground support equipment to a passenger boarding bridge.

10. The ground support equipment according to claim 1, comprising a housing, and wherein the PCA unit and the GPU are arranged in the housing.

11. The ground support equipment according to claim 10, wherein the PCA unit comprises an air duct for conveying air through the PCA unit, wherein the air duct has a first stage air duct and a narrowed section.

12. The ground support equipment according to claim 11, wherein the air duct has a second stage air duct that is joined to the first stage air duct at the narrowed section within the housing of the ground support equipment, and wherein at least some components of the GPU are housed between the narrowed section and the housing of the ground support equipment.

13. The ground support equipment according to claim 11, wherein a blower fan is located at the narrowed section of the air duct and operable to drive air through the air duct.

14. The ground support equipment according to claim 1, comprising a PCA housing with the PCA unit arranged therein, and a GPU housing with at least a part of the GPU arranged therein, and wherein the GPU housing is separate to the PCA housing.

15. The ground support equipment of claim 14, wherein an inverter of the GPU is disposed in the GPU housing.

16. The ground support equipment according to claim 1, comprising a rechargeable battery, configured to provide the power source to the input stage.
